(19) United States
(12) Patent Application Publication
(10) Pub. No.: US 2025/0059012 A1
(43) Pub. Date: Feb. 20, 2025

(54) DEVICE FOR DETECTING AND HANDLING DIFFERENT TYPES OF LOAD CARRIERS ON AN UNDERRIDE SHUTTLE

(71) Applicant: Jungheinrich Aktiengesellschaft, Hamburg (DE)

(72) Inventors: Martin Schöpp, Mering (DE); Marius Leffler, Aichach (DE); Romano Wolf, München (DE)

(21) Appl. No.: 18/802,395

(22) Filed: Aug. 13, 2024

(30) Foreign Application Priority Data
Aug. 17, 2023 (DE) 10 2023 122 082.9

(51) Int. Cl. B66F 9/075; B66F 9/06; B66F 9/065

(52) U.S. Cl. CPC B66F 9/0755; B66F 9/063; B66F 9/065

(57) ABSTRACT

The present invention relates to a device (22) for detecting and handling different types of load carriers on an underride shuttle (10), comprising a first sensor arrangement (18) which is designed to detect correct pickup of a load carrier on a load-carrying platform (14) of the underride shuttle (10) and to output corresponding first sensor data, a second sensor arrangement (20) which is of a different sensor type than the first sensor arrangement (18) and is designed to detect information regarding the type of load carrier and to output corresponding second sensor data, and a control unit (24) which is operatively coupled to the first sensor arrangement (18) and the second sensor arrangement (20) in order to obtain the first and second sensor data, wherein the control unit (24) is designed to output control signals based on the detected type of load carrier when the first sensor arrangement (18) detects correct pickup of the load carrier, which control signals are intended for adapting at least one operating parameter of the underride shuttle (10).

The present invention relates to a device for detecting and handling different types of load carriers on an underride shuttle, an underride shuttle comprising such a device, a system formed from such an underride shuttle and a plurality of load carriers of different types, and a method for detecting and handling different types of load carriers on an underride shuttle by means of a device according to the invention.

As part of the increasing automation of logistics facilities, so-called underride shuttles have recently become increasingly important. These can autonomously or semi-autonomously transport loads on their top, such as different types of pallets, tables or trays with goods carried on them. For this purpose, such underride shuttles are equipped with a vehicle body with wheels on it and with a height-adjustable load-carrying platform or loading area.

In order to pick up the mentioned type of loads and in particular load carriers, these are driven under by a corresponding underride shuttle either directly in the case of tables or in a transfer station in the case of pallets or trays, and the loading area or load-carrying platform on the top of the underride shuttle is raised until the load is lifted off the ground or the transfer station, is carried on the underride shuttle, and can then be transported to a designated location and transferred again or put down. For the purpose of transporting the loads mentioned, underride shuttles of the type in question are usually designed for omnidirectional movement and their operation is coordinated and controlled via a guide system.

Since the specific type of load carrier carried on such underride shuttles can have an influence on various work processes and/or operating parameters of the underride shuttle, for example in that an adaptation of a protective field spanned by environmental sensors around the underride shuttle to the size or the projection of the load carrier with respect to an outline of the underride shuttle may be necessary, it is desirable to be able to automatically recognize a type of a respective load carrier carried on an underride shuttle. Since safety-relevant operating parameters of the corresponding underride shuttle are affected in this case, it is also desirable here to carry out the corresponding detection in a manner that can exclude incorrect determinations of types of load carriers with a high degree of reliability. Furthermore, it is of course also desirable to design a corresponding device for detecting different types of load carriers at low cost and in a manner that is easy to install, maintain and operate.

Furthermore, especially when transporting heavy loads, it is essential to ensure that they are correctly aligned and positioned on an underride shuttle before the actual transport process begins. Specifically, if a load is applied in an unforeseen manner, undesirable conditions could arise in certain operating situations, such as fast cornering or abrupt braking, which could cause the load to slip or even tip over. Since the loads carried by corresponding underride shuttles can be considerable, such slipping or tipping of such a load carrier involves considerable recovery effort, which can lead to a shutdown of the corresponding logistics facility and high follow-up costs. Thus, in addition to the detection of the type of load carrier being carried, as discussed above, it is also essential to ensure that it is correctly positioned and aligned on the underride shuttle before the actual transport of it begins. In addition, elements for fixing the load in a receiving position can be provided on the vehicle, such as locking elements or recesses that interact with the load and are intended to prevent the load from slipping during the journey. However, this is only possible if the load is picked up correctly, so that the detection of the correct pick-up position is also important from this point of view for safe transport. Since in this case the corresponding protective fields are spanned by sensors that are attached to the underride shuttle, a correspondence of the protective fields intended for the respective detected load carrier to its outer contour can be guaranteed only if the load is correctly picked up and fixed.

It is therefore the object of the present invention to provide a device for detecting and handling different types of load carriers on an underride shuttle, which on the one hand can ensure correct positioning of a corresponding load carrier on the underride shuttle and on the other hand can also determine a type of load carrier, it being intended to be taken into account that in practical use a plurality of different types of load carriers can be used, it being possible for this number to be in the order of several dozen or even over 100.

For this purpose and to achieve the object formulated above, the device according to the invention for detecting and handling different types of load carriers on an underride shuttle comprises a first sensor arrangement which is designed to detect a correct pick-up of a load carrier on a load-carrying platform of the underride shuttle and to output corresponding first sensor data, a second sensor arrangement which is of a different sensor type than the first sensor arrangement and is designed to detect information regarding the type of load carrier and to output corresponding second sensor data, and a control unit which is operatively coupled to the first sensor arrangement and the second sensor arrangement in order to receive the first and second sensor data, the control unit being designed to output control signals based on the detected type of load carrier when the load carrier is correctly picked up by the first sensor arrangement, which control signals are intended to adapt at least one operating parameter of the underride shuttle.

By integrating two different sensor types in a device according to the invention, it is possible, on the one hand, to specifically determine with high precision a correct alignment of a load carried on an underride shuttle, while on the other hand, with the aid of the second sensor arrangement, a large number of different types of load carriers can be distinguished and the at least one operating parameter, addressed, of the underride shuttle can be adapted accordingly.

In this case, the different types of load carriers can, for example, refer to their geometry and in particular their external dimensions and/or their weight. At the same time, it should be pointed out that in the case of load carriers having a non-square or otherwise non-rotationally symmetrical outline in plan view with respect to all possible receiving configurations, several possible orientations thereof with respect to the vehicle body of the underride shuttle can also be understood as different types of load carriers within the meaning of the present invention. At this point, it should also be noted that although the adjustment of a protective field, mentioned above and discussed in more detail below, is to be understood as an example of an adjustment of at least one operating parameter of the underride shuttle, other operating parameters can also be adjustable here, for example a maximum permissible speed and/or acceleration and/or a minimum permissible curve radius of the underride shuttle.

Furthermore, it should be noted at this point that if the first sensor arrangement detects that a load carrier has not been picked up correctly, suitable measures can also be initiated automatically, for example notifying an operator or even immediately shutting down the corresponding vehicle, or alternatively also parking or setting down the corresponding load carrier and, if necessary, carrying out another attempt to pick it up correctly.

With regard to the design of the first sensor arrangement, in various embodiments of the device according to the present invention this can comprise at least one inductive sensor and/or at least one optical sensor, in particular at least one light barrier, and/or the first sensor arrangement can be position-sensitive in the millimeter range, i.e. that a positioning of the corresponding load carrier can be determined with an accuracy of less than 1 cm. In this case, the inductive sensor mentioned can interact with a corresponding passive element on the charge carrier, for example a simple metal portion, which can trigger a signal due to its inductance when present in the vicinity of the corresponding sensor in the range of the specified accuracy, while an optical sensor and in particular a light barrier detects the presence of a charge carrier or a portion thereof in a predetermined spatial area in a known manner.

In order to further improve the reliability of detecting the correct pickup of the load carrier, the first sensor arrangement can comprise at least two spaced sensors, which can preferably be arranged opposite one another, in particular diagonally opposite one another, on the underride shuttle. Accordingly, the at least two sensors of the first sensor arrangement can be positioned, for example, in the region of opposite corners on the upper side of the underride shuttle. Alternatively, the sensor arrangement can detect the load carrier in two orthogonal spatial directions, for example by means of two optical measuring devices oriented perpendicularly to each other.

In contrast, the second sensor arrangement can, for example, comprise a unit for reading out a passive or active data carrier assigned to the load carrier, for example an NFC, RFID, Bluetooth LE or QR code reading unit. The above examples of passive and active data carriers that can be assigned to the load carriers each enable coding of larger amounts of data, which are suitable for distinguishing and identifying an almost arbitrarily large number of different types of load carriers. In particular, the second arrangement can be designed to be able to distinguish at least 10, preferably at least 100, different types of load carriers, the specific number being dependent on the amount of data that can be encoded on the corresponding selected data carrier in each case.

Preferably, the second sensor unit is designed to read corresponding data carriers with a tolerance of more than 1 cm, in particular at least 10 cm. This ensures a certain minimum distance, so that the corresponding load carrier does not have to rest on the sensor, in order to avoid mechanical stress. On the other hand, a detection range that is too large could lead to incorrect identifications, for example if there are other data carriers in the load to be transported. The provision of the corresponding tolerance also means that the arrangement of a corresponding data carrier on the load carrier or the load is not position-sensitive or has a certain tolerance. Specifically, NFC or Bluetooth LE units, for example, would not have to be placed on the load carrier with an accuracy of 1 cm in order to be reliably read by the underride shuttle. Similarly, in the case of barcodes or QR codes as data carriers, the tolerance means that the optical unit for reading such a code can read it in a range of (1 cm×1 cm+size of the code), in particular (10 cm×10 cm+size of the code).

Further preferably, the second sensor unit is designed to read different data carriers in different rotational positions of the load carrier or the load relative to the underride shuttle. Since the underride shuttle and/or the load carrier usually have rotational symmetry, the load or the load carrier can be picked up in various ways. In such a case, it can be provided that different data carriers are present on the load or the load carrier, and at least one second sensor unit is arranged on the underride shuttle. In this case, the range of the data connection or the data transmission technology between the second sensor unit and the data carrier is selected in such a way that, depending on the orientation of the load and the underride shuttle, only exactly one data carrier is read out and the relative orientation can be derived from this. For example, a load carrier of type A with dimensions of 300 mm×400 mm corresponds to a load carrier with dimensions of 400 mm×300 mm when rotated by 90°.

It should also be noted at this point that, for example, geometric data and/or, for example, the permissible weight of the corresponding load carrier can be encoded directly on the passive or active data carriers mentioned, which in principle enables any number of load carriers to be distinguished, while on the other hand it would also be conceivable to provide an identifier for a specific design of load carrier or a type ID of the load carrier, which can be compared with type data stored in a data storage device assigned to the control unit, in order to be able to derive therefrom the required information about the corresponding type of load carrier.

According to a further aspect, the present invention relates to an underride shuttle comprising a vehicle body with a plurality of wheels, a load-carrying platform that can be displaced vertically relative to the vehicle body, a device for detecting and handling different types of load carriers on the underride shuttle of the type according to the invention just described, and a central control unit, the central control unit of the underride shuttle being operatively coupled to or integrated with the control unit of the device. Thus, the functionality of the control unit of the device can also be provided directly by the central control unit of the underride shuttle or a solution with distributed hardware can be used, which can allow an increased degree of modularization, the two control units mentioned above then being in communicative connection with each other.

As already indicated above, the underride shuttle according to the invention can comprise at least one scanner unit which is designed to monitor a protective field in the surroundings of the underride shuttle for the presence of objects, it being possible for the central control unit of the underride shuttle or a further control unit coupled to the central control unit, for example of a dedicated security system, to be designed to adapt this protective field on the basis of the detected type of load carrier. This is necessary for geometric reasons, as the received load carriers typically protrude beyond the outline of the underride shuttle. Such protective fields can also be adaptable to different operating parameters of the vehicle, such as its speed or its current direction of movement.

In this case, the at least one scanner unit mentioned serves to prevent collisions with moving and immovable objects and represents an essential safety device for such underride shuttles. For this purpose, it is possible to draw on LIDAR sensors, for example, which are used in combination with monitoring the speed and steering of the underride shuttle. Accordingly, in the above-described embodiment according to the invention of an underride shuttle, a dedicated geometry of such protective fields can be initialized depending on the respective geometry of the load carrier currently being carried, and the correct and correlated fields can be activated and monitored during operation of the underride shuttle. In particular, in this context it can be provided that dimensions, mass, permissible total mass or other parameters of the load carrier or the load are stored on the data carrier and that the operating parameters are determined from this by the underride shuttle, or that the operating parameters of the underride shuttle intended for transport, such as speed and/or acceleration limits and/or protective field dimensions, are stored directly on the data carrier. This represents a significant improvement in the safety function explained above compared to previously known designs of underride shuttles from the prior art, in which the shape and size of the protective fields as well as, for example, speed and steering limits, were intended only for a single intended load type, and a complex reconfiguration of the corresponding scanner units and the internal safety application of the underride shuttle was necessary, up to and including a change in the source code that was executed by the corresponding control units if such an underride shuttle was intended to transport a different type of load carrier.

Alternatively or in addition to the above-mentioned adaptation of a protective field of at least one scanner unit based on the detected type of load carrier, the corresponding at least one operating parameter to be adapted can include a maximum speed, a maximum acceleration, a minimum curve radius and/or a maximum lateral acceleration of the underride shuttle, by means of which a safe transport of the load is ensured for the different types of load carriers in each operating situation of the vehicle.

Furthermore, it is conceivable to provide at least one further sensor unit on the underride shuttle according to the invention, for determining a further state parameter of the load carrier, the underride shuttle or its surroundings, for example a weight sensor unit which is set up to determine a weight of a picked up load carrier, it furthermore being possible for the central control unit to be set up to additionally take into account the at least one further state parameter when adjusting the at least one operating parameter of the underride shuttle. Accordingly, in such an embodiment, the aforementioned operating parameters, such as maximum speed or maximum acceleration, can be adapted based on both the type of load carrier and the additionally detected further state parameter.

Furthermore, the present invention relates to a system formed from an underride shuttle of the type just described and a plurality of load carriers of different types, each of which is designed to be able to be picked up and transported on the load-carrying platform of the underride shuttle, each of the load carriers being assigned at least one passive or active data carrier on which information relating to the type of load carrier is encoded. Again, this can either be directly stored data relating to the type of load carrier, for example geometric dimensions and/or a weight thereof, or a type ID or a unique identifier of the load carrier can be encoded, from which the control unit of the device according to the invention provided in the underride shuttle can derive the corresponding information by means of a database comparison. In particular, it could be provided here that the corresponding data carrier of each of the load carriers encodes a unique identifier, for example an alphanumeric code which is only assigned once and thus enables a 1:1 assignment to the respective load carrier.

According to a further aspect, the present invention relates to a method for detecting and handling different types of load carriers on an underride shuttle by means of a device according to the invention of the type described above, optionally in an underride shuttle according to the invention, comprising detecting a correct pickup of a load carrier on a load-carrying platform of the underride shuttle by means of the first sensor arrangement, detecting information regarding the type of load carrier by means of the second sensor arrangement, and, if the first sensor arrangement detects correct pickup of the load carrier, adjusting at least one operating parameter of the underride shuttle based on the type of load carrier.

As already explained in the context of the description of the underride shuttle according to the invention, the at least one operating parameter of the underride shuttle can include a protective field in the environment of the underride shuttle, a maximum speed, a maximum acceleration, a minimum curve radius and/or a maximum lateral acceleration of the underride shuttle.

Furthermore, the detection of information regarding the type of load carrier can be carried out in a redundant manner, either by means of redundant hardware, i.e. in particular by using a plurality of reading units associated with the second sensor arrangement, and/or by redundant, i.e. multiple, coding of the corresponding information on the at least one data carrier associated with the load carrier. This reliably excludes incorrect identification of load carriers and, for example, if the readings are not consistent between the at least two reading units, the operation of the vehicle can be stopped and a corresponding error message can be issued to an operator.

As a further security measure, the detection of information regarding the type of load carrier may further include validating the detected information. This can prevent unauthorized modification or duplication of one of the load carriers used here, which in the present case of application helps to protect safety-relevant parameters against such manipulation. In particular, for this purpose, a verification can already be carried out during the production of the load carriers, such that the data encoded on the corresponding data carrier matches the type of load carrier, whereupon a so-called “validation flag” can then be written onto the data carrier. As a validation of the detected information within the framework of the method according to the invention, the control unit of the corresponding vehicle can then only accept data carriers that have this validation flag. In technical terms, this can be implemented, for example, in such a way that hash values are calculated on the basis of a private key using logic known only in production and control, which values are based on the unique identifier of the corresponding load carrier and can be evaluated for validating the corresponding load carrier.

Further features and advantages of the present invention will become even more apparent from the following description of an embodiment, when this is considered together with the accompanying figures. In the figures, in detail:

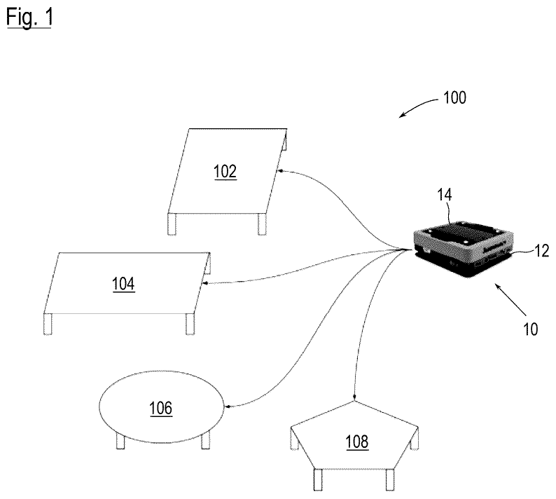

FIG. 1 is a schematic view of a system formed from an underride shuttle and a plurality of different load carriers;

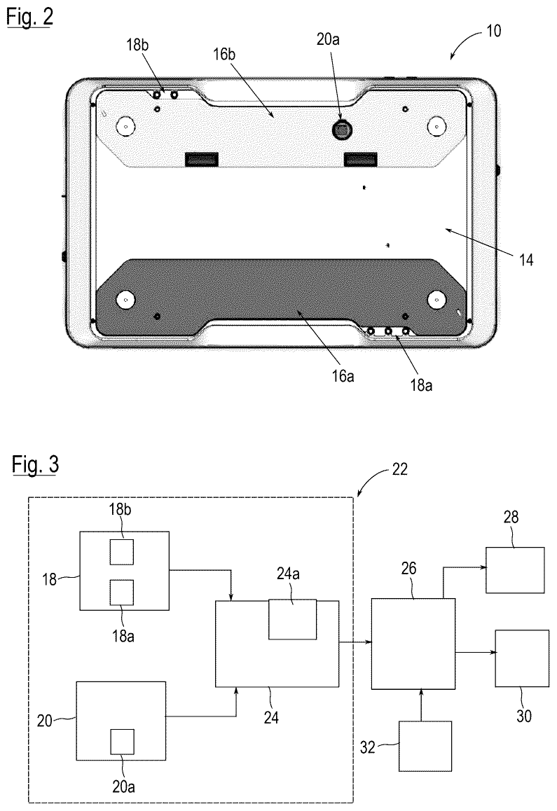

FIG. 2 is a plan view of the underride shuttle from FIG. 1;

FIG. 3 is a schematic view of the components of the device according to the invention for detecting and handling different types of load carriers of the underride shuttle from FIGS. 1 and 2;

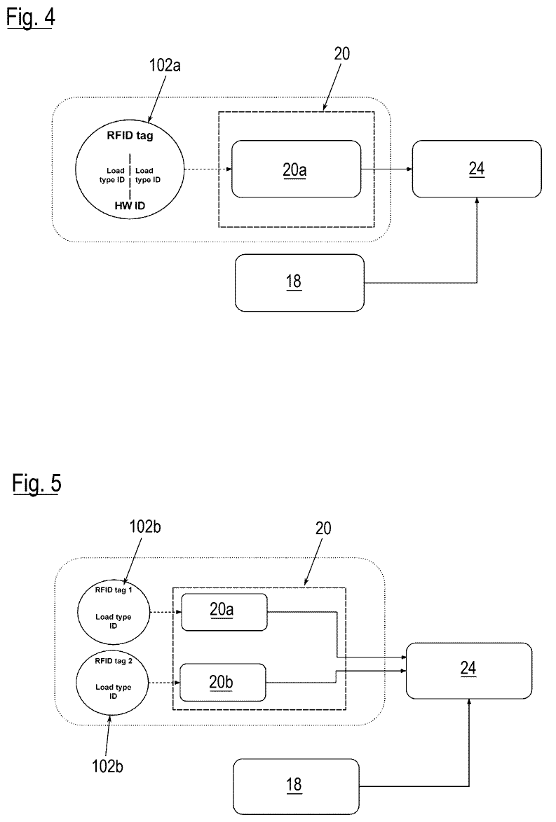

FIG. 4 is a schematic representation of a first variant of a detection of a type of load carrier on the underride shuttle from FIGS. 1 and 2; and

FIG. 5 is a schematic view of a second variant similar to that of FIG. 4.

FIG. 1 initially shows a schematic representation of a system 100 according to the invention, which is composed of an underride shuttle 10 according to the invention and a plurality of load carriers 102-108 of different types. In this case, the load carriers 102-108 have different shapes and external dimensions in plan view, but are all designed as load tables that can be driven under and lifted directly by the underride shuttle 10 and have different rotational symmetries. It should be noted that other types of load carriers could also be conceivable as part of the system 100, for example pallets or trays, which would then optionally have to be driven under in a suitable transfer station, since they themselves do not have sufficient construction height with respect to the ground.

The underride shuttle 10 in turn comprises a vehicle body 12, in which, among other things, some of the components described below are accommodated, as well as, for example, a drive system, an energy storage device, a control unit with corresponding peripheral devices, and a lifting device for the load-carrying platform 14, which is height-adjustable with respect to the vehicle body 12 and thus the ground and is set up to receive the load carriers 102-108.

In a variant not shown here, a corresponding underride shuttle can carry an interface unit which is designed to accommodate certain load carriers and comprises the first and second sensor units. In such a case, the underride shuttle and the corresponding interface unit shall be considered as a structural unit.

A plan view of the underride shuttle 10 and thus in particular of the upper side of the load-carrying platform 14 is furthermore shown in FIG. 2. It can be seen here that two support portions 16a and 16b are provided symmetrically on the upper side of the load-carrying platform 14, of which the lower one in FIG. 2 is provided with an anti-slip support, while for reasons of clarity this support has been omitted from the upper one in the illustration. In this case, projections, depressions or the like can also be provided on the upper side of the load-carrying platform, which can interact with corresponding counter-elements of the load carriers 102-108 in order to promote correct positioning and alignment in a picked-up state thereof.

Furthermore, two fields of inductive sensors 18a and 18b are provided on the upper side of the load-carrying platform 14, which are arranged diagonally opposite one another. These fields of inductive sensors 18a and 18b each form part of a first sensor arrangement 18, which will be described further below in connection with FIG. 3 and serves to detect correct pickup of one of the load carriers 102-108 on the load-carrying platform 14. For this purpose, the load carriers 102-108 are provided with counter-elements at suitable locations on their undersides, for example metal portions and/or recesses and/or non-metal portions, which allow detection thereof at short range, thereby enabling the desired precision of detection in the millimeter range. It should be noted at this point that, alternatively, for example optical sensors could also be used as corresponding sensor units, in particular light barriers, by means of which such precise detection of a correct pickup of the load carriers 102-108 is also possible. Furthermore, it should be noted that, instead of the two opposing fields of sensors 18a and 18b used in this example, a different number of sensors could also be installed for this purpose as part of the first sensor arrangement 18.

Furthermore, an RFID reading unit 20a is provided on the upper side of the load-carrying platform 14, which forms part of a second sensor arrangement 20 and is configured to read an RFID tag attached at a suitable position on the load carriers 102-108, in order to acquire information regarding the type of load carrier that is encoded on the RFID tag. At this point, it should be noted that other technologies could also be used for the second sensor arrangement 20, for example an NFC, Bluetooth LE or QR code reading unit, if the load carriers 102-108 are accordingly equipped with such active or passive data carriers. Furthermore, configurations are also conceivable in which the second sensor arrangement 20 comprises more than one reading unit 20a, for example for reasons of redundancy or plausibility. In any case, the data volumes that can be encoded by the data carriers mentioned are sufficient to be able to clearly identify an almost unlimited number of different types of load carriers for practical use, and their respective ranges are also suitable for the operation just outlined.

With reference to FIG. 3, on the basis of the schematic diagram shown there, the components of a device according to the invention for detecting and handling the different types of load carriers 102-108 of the underride shuttle 10 from FIGS. 1 and 2 are to be explained. The device itself is designated as a whole with the reference numeral 22 in FIG. 3, FIG. 3 furthermore showing further components of the underride shuttle 10, which are not to be understood as components of the device 22.

As already mentioned, the device 22 comprises the first sensor arrangement 18 with its two fields of inductive sensors 18a and 18b on the upper side of the underride shuttle 10 for outputting sensor data, which indicate a correct pickup of one of the load carriers 102-108 on the load-carrying platform 14. Similarly, the device 22 comprises the second sensor arrangement 20 with its RFID reading unit 20a, which outputs information regarding the type of load carrier 102-108. In this case, the respective sensor data are output to a control unit 24, which processes them in a suitable manner, for example by assigning identification data supplied by the second sensor arrangement 20 to a specific type of load carrier 102-108 via a lookup table stored in an associated memory 24a and, on this basis, outputting control signals which are intended to adapt at least one operating parameter of the underride shuttle 10. It is also conceivable that the control unit 24 queries the required data for the detected data carrier by means of a wireless communication connection (not shown), such as WLAN, from a central unit of the logistics facility in which the underride shuttle 10 is operated.

For this purpose, the control unit 24 can, as shown in FIG. 3, be communicatively coupled to a central control unit 26 of the underride shuttle 10, while in an alternative variant the functionality of the control unit 24 could also be taken over directly by the central control unit 26, so that only a single piece of hardware would have to be used here, such as a suitable microprocessor or controller.

In any case, when the first sensor unit 18 detects that a load carrier 102-108 has been correctly picked up, the central control unit 26 can now adapt the operation of various components of the underride shuttle 10 on the basis of the control signals from the control unit 24 of the device 22, for example a drive system 28 (shown here only schematically), with regard to a maximum permissible speed, acceleration or lateral acceleration or a maximum permissible curve radius.

Alternatively or additionally, a protective field of at least one scanner unit 30 can be adapted on the basis of the detected type of load carrier 102-108, in which case the outline of such a load carrier 102-108 would have to be taken into account in particular. It should be noted here that, in a further variant not shown here, an additional separate control unit can also be provided for adapting the protective fields, which can form part of a dedicated safety system of the underride shuttle 10 and would also be in communicative connection with the central control unit 26.

On the other hand, if the correct pickup of a load carrier 102-108 is not detected in an operating state in which such pickup would be provided, suitable measures can also be taken, for example notifying a human operator via suitable communication and/or display means, and/or temporarily shutting down the underride shuttle 10 as a whole.

Furthermore, it should be noted that at least one further sensor unit 32 can be included in the underride shuttle 10, for example a weight sensor unit which detects a weight of a picked-up load carrier 102-108. The data thus determined can also be taken into account by the central control unit 26 when adjusting the at least one operating parameter.

With reference to FIGS. 4 and 5, two specific embodiments of variants of detecting a type of load carrier 102-108 on the underride shuttle from FIGS. 1 and 2 using the device 22 from FIG. 3 will now be explained. Here, FIG. 4 shows an example corresponding to that of FIGS. 2 and 3, in which only a single RFID reading unit 20a is used, while in the alternative variant from FIG. 5 two such reading units 20a, 20b are used. For reasons of readability, the first load carrier 102 from FIG. 1 is used as an example here.

In the variant from FIG. 4, a total of three data portions are provided on the RFID tag 102a assigned to the corresponding load carrier 102, two of which independently and redundantly encode a type identifier (load type ID) of the corresponding type of load carrier 102, while the remaining third data portion encodes a unique hardware identifier (HW ID) of the specific load carrier 102. In this case, the second sensor unit 20 processes the first type identifier together with the hardware identifier, and then, in a second step, the other type identifier, also together with the hardware identifier. After this, for example, the control unit 24 compares whether the two type identifiers match and were read from the same load carrier 102, by additionally comparing the hardware identifiers read out in the two steps. Parallel to this data stream from the second sensor arrangement 20, a further data stream is processed by the control unit 24, which originates from the first sensor arrangement 18 and relates to a correct pickup of the load carrier 102 on the underride shuttle 10.

In the alternative variant of FIG. 5, in addition to the data stream from the first sensor arrangement 18, two RFID tags 102b on the load carrier 102 are read independently of one another by separate and sufficiently spaced RFID readers 20a, 20b, each of which encodes only one type identifier, in order to achieve redundancy and plausibility that meets the highest security standards. Thus, the two variants shown in FIGS. 4 and 5 can each be used, for example, to adapt protective fields in the underride shuttle 10 depending on the type of load carrier to be picked up, without this impairing the operational safety of the underride shuttle 10.

In both examples shown in FIGS. 4 and 5, reading the load type ID twice serves to increase security or to achieve a specified security standard. Since reading the load type ID or recognizing the load carrier is a safety-relevant functionality that has a direct impact on the operational safety of the underride shuttle 10, redundant recognition of the load carrier type is necessary.

Furthermore, it should be noted that a further data portion can be provided on the RFID tags 102a, 102b, which serves as a validation flag, the control unit 24 in this context only accepting load carriers 102-108 on whose RFID tags 102a, 102b a valid validation flag is encoded. These can already be generated in the production of the respective load carrier 102-108 by means of suitable cryptographic methods, and then validated by the control unit 24 during the reading of the corresponding RFID tag 102a, 102b, for example using a hashing method that is known per se.

1. A device for detecting and handling different types of load carriers on an underride shuttle, the device comprising:
a first sensor arrangement designed to detect a correct pickup of a load carrier on a load-carrying platform of the underride shuttle and to output corresponding first sensor data;
a second sensor arrangement having a different sensor type than the first sensor arrangement and designed to detect information regarding a type of load carrier and to output corresponding second sensor data; and
a control unit operatively coupled to the first sensor arrangement and the second sensor arrangement to obtain the first and second sensor data, wherein the control unit is configured to output control signals to adapt at least one operating parameter of the underride shuttle in response to detecting the correct pickup of the load carrier by the first sensor arrangement and based on the type of load carrier detected by the second sensor arrangement.

2. The device according to claim 1, wherein the first sensor arrangement comprises at least one inductive sensor.

3. The device according to claim 1, wherein the first sensor arrangement comprises at least two spaced sensors.

4. The device according to claim 1, wherein the second sensor arrangement comprises a unit for reading a data carrier assigned to the load carrier.

5. The device according to claim 1, wherein the second sensor arrangement is configured to distinguish at least 10 different types of load carriers.

6. An underride shuttle comprising:
a vehicle body having a plurality of wheels;
a load-carrying platform displaced vertically relative to the vehicle body;
a device for detecting and handling different types of load carriers on the underride shuttle, where the device comprises:
a first sensor arrangement designed to detect a correct pickup of a load carrier on the load-carrying platform of the underride shuttle and to output corresponding first sensor data;
a second sensor arrangement having a different sensor type than the first sensor arrangement and designed to detect information regarding a type of load carrier and to output corresponding second sensor data; and
a control unit operatively coupled to the first sensor arrangement and the second sensor arrangement to obtain the first and second sensor data, wherein the control unit is configured to output control signals to adapt at least one operating parameter of the underride shuttle in response to detecting the correct pickup of the load carrier by the first sensor arrangement and based on the type of load carrier detected by the second sensor arrangement; and
a central control unit operatively coupled to the control unit of the device.

7. The underride shuttle according to claim 6, further comprising at least one scanner unit configured to monitor a protective field in an environment surrounding the underride shuttle for a presence of objects, wherein the central control unit of the underride shuttle is configured to adapt the protective field based on the type of load carrier.

8. The underride shuttle according to claim 6, wherein the at least one operating parameter includes a maximum speed, a maximum acceleration, a minimum curve radius or a maximum lateral acceleration of the underride shuttle.

9. The underride shuttle according to claim 6, further comprising at least one further sensor unit for determining a further state parameter of the load carrier, the underride shuttle, or an environment surrounding the underride shuttle, wherein the central control unit is configured to adapt the at least one operating parameter of the underride shuttle based on the further state parameter.

10. The underride shuttle according to claim 6, wherein the underride shuttle is configured to pick up the different types of load carriers and transport the different types of load carriers using the load-carrying platform.

11. (canceled)

12. A method for detecting and handling different types of load carriers on an underride shuttle, the method comprising:
detecting, using a first sensor arrangement of a device, a correct pick-up of a load carrier on a load-carrying platform of the underride shuttle;
detecting, using a second sensor arrangement of the device, information regarding a type of load carrier; and
adjusting at least one operating parameter of the underride shuttle in response to detecting a the correct pick-up of the load carrier and based on the type of load carrier.

13. The method according to claim 12, wherein the at least one operating parameter of the underride shuttle comprises a protective field in an environment surrounding the underride shuttle, a maximum speed, a maximum acceleration, a minimum curve radius or a maximum lateral acceleration of the underride shuttle.

14. The method according to claim 12, wherein the second sensor arrangement comprises a plurality of reader units configured to detect the type of load carrier.

15. The method according to claim 12, further comprising:
validating the information regarding the type of load carrier.

16. The device according to claim 1, wherein the first sensor arrangement comprises at least one optical sensor.

17. The device according to claim 16, wherein the at least one optical sensor comprises at least one light barrier.

18. The device according to claim 1, wherein the first sensor arrangement is position-sensitive in a millimeter range.

19. The device according to claim 3, wherein the at least two spaced sensors are arranged opposite to one another on the underride shuttle.

20. The device according to claim 3, wherein the at least two spaced sensors are positioned diagonally opposite to one another on the underride shuttle.

21. The device according to claim 4, wherein the data carrier comprises at least one of a NFC, a RFID, a Bluetooth LE, and a QR code.

22. The underride shuttle according to claim 7, further comprising a third control unit coupled to the central control unit and configured to adapt the protective field based on the detected type of load carrier.

23. The underride shuttle according to claim 9, wherein the at least one further sensor unit comprises a weight sensor unit configured to determine a weight of the load carrier.

24. The underride shuttle according to claim 6, wherein the load carrier comprises at least one data carrier comprising encoded information about a type of load carrier associated with the load carrier.

25. The underride shuttle according to claim 24, wherein the at least one data carrier encodes a unique identifier.

26. The method according to claim 12, wherein the second sensor arrangement is configured to detect the type of load carrier by reading at least one data carrier associated with the load carrier, wherein the at least one data carrier comprises coded information about the load carrier.
